(19) United States
(12) Patent Application Publication
(10) Pub. No.: US 2024/0240066 A1
(43) Pub. Date: Jul. 18, 2024

(54) REACTIVE ADHESIVE TAPE THAT CAN BE STAMPED

(71) Applicant: TESA SE, Norderstedt (DE)

(72) Inventors: Bastian KRUSKOP, Norderstedt (DE); Yvonne QUERDEL, Ahrensburg (DE); Christian SCHUH, Hamburg (DE); Nadine WEDEL, Hamburg (DE)

(21) Appl. No.: 18/574,602

(22) PCT Filed: Jun. 24, 2022
(86) PCT No.: PCT/EP2022/067344

§ 371 Date: Dec. 27, 2023

(30) Foreign Application Priority Data
Jun. 30, 2021 (DE) 10 2021 206 799.9

(51) Int. Cl. C09J 163/00; C09J 7/24; C09J 7/38; C09J 11/06; C09J 133/10

(52) U.S. Cl. CPC C09J 163/00; C09J 7/243; C09J 7/38; C09J 11/06; C09J 133/10; C09J 2301/124; C09J 2301/302; C09J 2301/408; C09J 2301/412; C09J 2400/24; C09J 2463/00

(57) ABSTRACT

The invention relates to a curable adhesive tape which firstly can be easily positioned on a substrate prior to curing ml the form of a pressure-sensitive adhesive tape and after curing has extremely high adhesive strength and good shock resistance, and secondly can also be easily stamped into very narrow shapes. This is achieved with a reactive adhesive tape which comprises a film, a first outer reactive adhesive composition and a second outer reactive adhesive composition and is characterised in that at least one of the reactive adhesive compositions comprises at least one reactive component, at least one photoinitiator, one or more foaming agents and at least one polymer, and said reactive adhesive composition is foamed.

The invention is located in the technical field of reactive adhesive tapes, of the kind increasingly used in numerous areas of industry. More specifically, the invention proposes a particular adhesive tape construction with a foil and at least one foamed outer reactive adhesive.

The joining of separate elements is one of the central processes in manufacturing. As well as other methods, such as welding and soldering, for example, an important significance is nowadays accorded in particular to adhesive bonding, i.e., to joining using an adhesive. An alternative here to the use of formless adhesives, applied for example from a tube, are so-called adhesive tapes. An advantageous feature of adhesive tapes is that they can be applied substantially more easily and with more positional accuracy than can liquid adhesives. They are therefore suitable especially for miniaturized applications, as required for example in the electronics industry. An increasingly important factor here is to realize the bonds between the components very precisely and in a space-saving manner. Moreover, on account of the still considerable demand worldwide for electronics for communications and entertainment, there is also a steady increase in the requirements regarding the performance capacity of the devices, which means that the adhesive tapes used as well are continually subject to new, or at least growing, requirements in terms of their performance.

In this context, reactive adhesive tapes which cure at room temperature are needed not only but in particular for applications in the electronics market, e.g., in the production of smart phones or notebook computers. Owing to the trend already described toward miniaturization, these tapes have to have increasingly narrower geometries; land widths of less than 0.5 mm are presently required.

Moreover, the adhesive tapes have to satisfy exacting performance requirements. It is necessary, for instance, for the bonds to withstand even the sharpest jolts, as occur, for example, if the device is dropped. It is therefore necessary to realize very high bond strengths, exceeding the performance level of customary pressure-sensitive adhesive tapes. Increasingly, therefore, what are called reactive adhesive tapes are coming under the spotlight. These are adhesive tapes which cure under an external influence, for example, under the influence of moisture or high-energy radiation, by means of a chemical reaction triggered by the external influence, and which in general attain very high bond strengths.

WO 2017/174303 A1, for instance, describes a tacky adhesive tape which contains a radiation-activatable polymerizable composition which in turn contains
A 5 to 60 parts by weight of at least one film-former component;
B 40 to 95 parts by weight of at least one epoxy component;
C 0.1 to 10 parts by weight of at least one photoinitiator; and
D optionally 0.1 to 200 parts by weight of at least one adjuvant, based in each case on the radiation-activatable polymerizable composition, the parts by weight of components A and B adding up to 100, and which is characterized in that the film-former component A comprises or consists of at least one polyurethane polymer.

To enable user-friendly joining of the components, though, the adhesive tapes prior to curing are to be extremely tacky (exhibiting pressure-sensitive adhesion), allowing them to be first placed by means of a gentle pressure, achievable solely with the fingers, and even allowing their provisional position to be corrected again where necessary. A disadvantage of such adhesive tapes is that their tackiness is frequently accompanied by reduced cohesion in the uncured state. This in turn is contrary to a further requirement—the adhesive tapes, as part of their production, are to be able to be diecut to the required, often miniaturized, geometries. But diecutting is made much, much more difficult by the reduced cohesion.

It is established knowledge that the diecuttability of an adhesive tape can be improved significantly through the incorporation of a foil. In this context, WO 2017/140801 A1 describes a pressure-sensitive adhesive strip made up of at least four, more particularly exactly four, layers, comprising
a layer A with a top side and a bottom side composed of a foamed adhesive which is based on a self-adhesive acrylate composition,
a layer B composed of a foil carrier, the layer B being disposed on the bottom side of the layer A, with at least the main face facing the layer A, preferably both main faces of the foil carrier, being etched, where the surface of the layer A and the surface of the layer B are in direct contact with one another,
a layer C composed of a self-adhesive composition which is disposed on the top side of the layer A and is based on a self-adhesive acrylate composition,
a layer D composed of a self-adhesive composition which is disposed on the side of the layer B opposite the layer A and which is based on a self-adhesive acrylate composition.

Another observation, however, is that foils introduced into an adhesive tape lead to reduced shock resistance on the part of the adhesive tapes. In summary, there is a considerable demand apparent for adhesive tapes which are able to satisfy the contrary requirements outlined, while affording high bonding performances overall.

It was an object of the invention to provide a curable adhesive tape
which firstly, prior to curing, can be easily positioned as a pressure-sensitive adhesive tape on a substrate and which, after curing, has very high peel adhesion and good shock resistance, and
which secondly has good diecuttability even in very narrow geometries.

A supplementary object of the invention was to configure the adhesive tape such that it has a sufficient open time of at least one minute, more particularly of at least five minutes, thus not curing immediately after the initiation of curing, but instead still largely retaining its pressure-sensitive adhesive properties for the specified period.

The achievement of these objects is based on the concept of equipping an adhesive tape with a foil and with a foamed reactive adhesive.

A first and general subject of the invention is therefore a reactive adhesive tape which comprises
a foil;
a first outer reactive adhesive; and
a second outer reactive adhesive and which is characterized in that at least one of the reactive adhesives is foamed.

As has emerged, adhesive tapes of the invention are able to cover the required spectrum of objects.

A reactive adhesive tape is an adhesive tape which has at least one actively bonding layer which under an external influence, more particularly under the influence of moisture or high-energy radiation, cures to a technically relevant extent, or with significant change in at least one application-related property, to achieve bond strengths which go well above the level of customary pressure-sensitive adhesives or customary pressure-sensitive adhesive tapes. This is manifested in particular in lap-shear values. Thus very good pressure-sensitive adhesive tapes attain values of around 1 MPa, and reactive adhesive tapes values in the region of 3 MPa.

The term “adhesive tape” is clear to the person skilled in the art of adhesive technology. In the context of the present invention, the expression “tape” denotes all thin, sheetlike structures, i.e., structures with a predominant extent in two dimensions, especially tapes with extended length and limited width, and also corresponding tape portions; furthermore, the term also embraces, for example, diecuts (in the form of surrounds or enclosures of an (opto)electronic arrangement, for example) and labels. An adhesive tape may be offered for example in wound form as an adhesive tape roll or in the form of a cross-wound spool.

The reactive adhesive tape of the invention comprises a foil. A “foil” in accordance with the invention is a uniform sheet structure composed of metal or plastic which does not itself develop any direct bonding effect with respect to a substrate that is to be bonded.

In the invention, the foil is preferably a plastics foil, more particularly a polymer foil. The foil may have a single-layer or multilayer configuration; a multilayer foil construction may be produced by coextrusion, by extrusion coating or by lamination using an adhesive. The foil material is arbitrary in principle, provided it does not oppose compliance with the objects of the invention.

The foil is preferably selected from the group consisting of polyethylene foils, based more particularly on HDPE, MDPE, LDPE, LLDPE and also copolymers and/or block copolymers of ethylene; polypropylene foils, based more particularly on monoaxially and/or biaxially oriented HOMO-, HECO- and/or recycled polypropylene (r-PP), oriented polypropylene (oPP); ethylene and/or propylene ionomer foils; foils based on MAn-grafted polymers; foils based on cyclic olefin copolymers (COC); polyvinyl chloride foils (PVC foils); polyester foils, based more particularly on biaxially oriented polyethylene terephthalate (PET) and/or polyethylene naphthalate (PEN) and also based on biodegradable polyesters, especially on polybutylene terephthalate (PBT), polybutylene adipate-terephthalate (PBAT), polybutylene succinate (PBS), polyisosorbitol terephthalate (PIT) and copolymers of these; polyethylene-vinyl alcohol foils (EVOH foils); polyethylene-vinyl acetate foils (EVA foils); polyvinylidene chloride foils (PVDC foils); polyvinylidene fluoride foils (PVDF foils); polyacrylonitrile foils (PAN foils); polycarbonate foils (PC foils); polyamide foils (PA foils); cellulose acetate foils; polymethyl methacrylate foils (PMMA foils); polyvinyl alcohol foils; polyurethane foils (PU foils); polyether sulfone foils (PES foils); paper foils; polyimide foils (PI foils), and also foils based on a blend of two or more of the materials stated here.

The foil may generally comprise additives, examples being fillers, antioxidants, lubricants, anti-blocking agents, dyes and/or pigments.

The foil is more preferably selected from the group consisting of polyethylene terephthalate foils (PET foils), polyethylene foils (PE foils), polypropylene foils (PP foils) and polyurethane foils (PU foils). The foil more particularly is a polyethylene terephthalate foil (PET foil), very preferably a PET foil based on biaxially oriented PET.

The skilled person is aware of diverse methods for improving the composite strength of reactive adhesive and foil. These methods encompass pretreatment processes, such as etching, corona, plasma, flaming, and furnishing with adhesion-boosting coatings (primers), for example. The foil in this context is more preferably an etched foil, more particularly an etched polyethylene terephthalate foil (PET foil).

The thickness, or layer thickness, of the foil is preferably 3 to 100 μm, more preferably 5 to 80 μm, more particularly 8 to 50 μm. For example, the thickness or layer thickness of the foil is 3 to 35 μm and very preferably 5 to 20 μm.

As has emerged, the foil stabilizes the adhesive tape and in particular improves its diecuttability. The foil in the context of the invention may also be denoted and understood as a “carrier foil” of the adhesive tape.

The reactive adhesive tape of the invention additionally comprises a first and a second outer reactive adhesive. As already observed herein, a “reactive adhesive” is an adhesive which under an external influence, more particularly under the influence of moisture or high-energy radiation, cures to a technically relevant extent, or with significant change in at least one application-related property, attaining, as it does so, bond strengths which significantly exceed the level of typical pressure-sensitive adhesives.

An “outer” reactive adhesive is a reactive adhesive which, in the construction of the adhesive tape, forms one of the two outward-facing layers and thus has a free surface which is not in direct contact with any further layer of the adhesive tape and is intended for direct contact with a substrate to be bonded.

The first outer and the second outer reactive adhesive are each disposed on the opposite sides of the foil, to form a double-sided adhesive tape. The reactive adhesive tape of the invention, accordingly, is a double-sided adhesive tape.

Preferably at least one of the two reactive adhesives is a radiation-curable adhesive; more preferably, both reactive adhesives are radiation-curable adhesives, more particularly UV-curable adhesives. Accordingly, preferably at least one of the two reactive adhesives comprises, and more preferably, independently of one another, both reactive adhesives each comprise, at least one reactive component and at least one photoinitiator, more particularly at least one UV initiator.

A second subject of the invention is therefore a reactive adhesive tape which comprises
a foil;
a first outer reactive adhesive; and
a second outer reactive adhesive;
   and which is characterized in that at least one of the reactive adhesives comprises
(i) at least one reactive component, especially preferably an epoxy resin,
(ii) at least one photoinitiator,
(iii) one or more foaming agents, especially preferably hollow spheres, and
(iv) at least one polymer at in total more than 60.0% by weight, based on the total weight of the reactive adhesive, and
   in that this reactive adhesive is foamed.

A reactive component in the invention refers to a component of the adhesive that under the influence of high-energy radiation, more particularly under the influence of UV radiation, crosslinks by a constructive chemical reaction to form macromolecular structures and so contributes significantly to the curing of the adhesive. In a borderline case, the reactive component effects the curing of the adhesive.

Reactive components, also referred to as reactive resins, differ significantly from tackifier resins that are frequently employed in adhesives, particularly in pressure-sensitive adhesives. A “tackifier resin” in accordance with the general understanding of the skilled person is an oligomeric or polymeric resin which merely increases the adhesion (the tack, the intrinsic stickiness) of the pressure-sensitive adhesive by comparison with the otherwise identical pressure-sensitive adhesive containing no tackifier resin. Apart from C—C double bonds (“unsaturated resins”), tackifier resins typically contain no reactive group, since their properties are intended not to change over the lifetime of the pressure-sensitive adhesive; accordingly, they also do not react to form macromolecular structures. Typical tackifier resins are exemplified by partially or fully hydrogenated resins based on rosin and rosin derivatives, hydrogenated polymers of dicyclopentadiene, partially, selectively or fully hydrogenated hydrocarbon resins based on C₅, C₅/C₉ or C₉ monomer streams, polyterpene resins based on α-pinene and/or β-pinene and/or δ-limonene and/or Δ3-carene, hydrogenated polymers of preferably pure C₈ and C₉ aromatics; terpene-phenol resins, rosins, and tackifier resins based on acrylates and methacrylates. Express reference is made to the depiction of the state of knowledge in the “Handbook of Pressure Sensitive Adhesive Technology” by Donatas Satas (van Nostrand, 1989, chapter 25 “Tackifier Resins”).

In the context of the invention, the reactive component is preferably an oxetane resin, an epoxy resin or a mixture of these resins; accordingly, preferably at least one of the two reactive adhesives comprises, and more preferably independently of one another both reactive adhesives each comprise, at least one oxetane resin, epoxy resin or a mixture of these resins.

An oxetane resin is a compound having at least one polymerizable oxetane group per molecule. Correspondingly, an epoxy resin is a compound having at least one polymerizable epoxide group per molecule. The oxetane/epoxide groups are polymerizable more particularly via a ring opening reaction. The resins in question may have one or more oxetane/epoxide groups. Their structure otherwise is arbitrary in principle; the resins may be monomeric, oligomeric or polymeric and may be aliphatic, cycloaliphatic or aromatic. Where the reactive adhesives comprise one or more polymers containing oxetane and/or epoxide groups, more particularly one or more poly(meth)acrylates of this kind, they are not included among the oxetane or epoxy resins. Polymeric oxetane/epoxy resins differ from these polymers in particular in their molecular weight, as they have a weight-average molecular weight of not more than 50 000 g/mol.

The reactive component is more preferably an epoxy resin; accordingly, preferably at least one of the two reactive adhesives comprises, and more preferably independently of one another both reactive adhesives each comprise, at least one epoxy resin.

The epoxy resin has preferably at least two, more preferably more than two, epoxide groups per molecule. In general, the average number of epoxide groups per molecule is reported, being obtained as the ratio of the total number of epoxide groups in the epoxy resin to the total number of epoxy resin molecules present. The epoxy resin preferably has on average more than two epoxide groups per molecule.

The epoxy resin may comprise linear polymers having terminal epoxide groups, examples being diglycidyl ethers of polyoxyalkylene glycols; polymers having framework oxirane units, examples being polybutadiene-polyepoxides; and polymers having epoxide side groups, examples being glycidyl methacrylate polymers or copolymers having a maximum molecular weight of M_{w}=50 000 g/mol.

The epoxy resin may also comprise materials having cyclohexene oxide groups, examples being epoxycyclohexanecarboxylates such as 3,4-epoxycyclohexylmethyl 3,4-epoxycyclohexanecarboxylate, 3,4-epoxy-2-methylcyclohexylmethyl 3,4-epoxy-2-methylcyclohexanecarboxylate and bis(3,4-epoxy-6-methylcyclohexylmethyl) adipate.

The epoxy resin may also comprise monomeric glycidyl ethers, examples being glycidyl ethers of polyhydric phenols, obtained by reaction of a polyhydric phenol with an excess of chlorohydrin such as epichlorohydrin, for example.

The epoxy resin may further comprise compounds such as octadecylene oxide, epichlorohydrin, styrene oxide, vinylcyclohexene oxide, glycidol, glycidyl methacrylate, diglycidyl ethers of bisphenol A, diglycidyl ethers of bisphenol F, vinylcyclohexene dioxide, 2-(3,4-epoxycyclohexyl-5,5-spiro-3,4-epoxy)cyclohexane-metadioxane, bis(3,4-epoxycyclohexyl) adipate, dipentene dioxide, epoxidized polybutadiene, epoxysilanes, e.g., β-(3,4-epoxycyclohexyl)ethyltrimethoxysilane and γ-glycidoxypropyltrimethoxysilane; flame-retardant epoxy resins, examples being brominated bisphenol-like epoxy resins; 1,4-butane-diol diglycidyl ether; hydrogenated, bisphenol A-epichlorohydrin-based epoxy resins (e.g., Epikote 828 LVEL) and polyglycidyl ethers of phenol-formaldehyde novolacs (e.g., Araldite ECN 1299).

Preferably at least one of the reactive adhesives comprises, and more preferably independently of one another both reactive adhesives each comprise, at least one cycloaliphatic epoxy resin, more particularly selected from the group consisting of 3,4-epoxycyclohexylmethyl 3,4-epoxycyclohexane carboxylate (e.g., Uvacure 1500 from Dow), 3,4-epoxy-2-methylcyclohexylmethyl 3,4-epoxy-2-methylcyclohexanecarboxylate and bis(3,4-epoxy-6-methylcyclohexylmethyl) adipate.

In one embodiment, preferably at least one of the reactive adhesives comprises, and more preferably independently of one another both reactive adhesives each comprise, at least one liquid and at least one solid epoxy resin.

The weight ratio of liquid epoxy resin to solid epoxy resin is more preferably 1:3 to 3:1. Where there are two or more liquid and/or solid epoxy resins present, the entirety of all liquid/solid epoxy resins is the reference point in each case.

Where they comprise one or more epoxy resins, the reactive adhesives independently of one another contain epoxy resins preferably at in total 18% to 60% by weight, based in each case on the total weight of the reactive adhesive. More particularly there are more than 20% by weight of such resins present, more preferably 20% to 50% by weight.

A preferred configuration according to the invention is therefore a reactive adhesive tape which comprises
a foil;
a first outer reactive adhesive; and
a second outer reactive adhesive;
   and which is characterized in that at least one of the reactive adhesives comprises
(i) at least one epoxy resin at in total 18% to 60% by weight,
(ii) at least one photoinitiator,
(iii) one or more foaming agents, and
(iv) at least one polymer at in total more than 60.0% by weight, more particularly 61.0% to 71.0% by weight, based on the total weight of the reactive adhesive, and
   in that this reactive adhesive is foamed.

In a further configuration of the reactive adhesive tape of the invention, the reactive component contains at least 10% by weight of epoxy resins which are liquid at 25° C., based on the total weight of the reactive component. The fraction of such liquid epoxy resins in the reactive component is more particularly 10% to 90% by weight, more preferably 20% to 75% by weight. In the uncured state, reactive adhesive tapes having such proportions of liquid and solid epoxy components exhibit particularly balanced adhesive properties. If the desire is for a reactive adhesive tape having particularly good flow-on properties, the fraction of liquid epoxy resins is preferably 50% to 80% by weight. For applications requiring the reactive adhesive tapes to bear a relatively high load even in the uncured state, a fraction of 15% to 45% by weight is more preferred. Either one liquid epoxy resin or else a mixture of different liquid epoxy resins may be used.

Preferred liquid epoxy resins are bisphenol-A diglycidyl ethers or bisphenol-F diglycidyl ethers having dynamic viscosities of less than 30 Pas at 25° C., available for example from Olin (formerly DOW) under the designation D.E.R. 331, 332, 383, 330, 317, 321, 3212, 322, 323, 324, 325, 329, 362, 353, 354; and cycloaliphatic epoxy resins, e.g., 3,4-epoxycyclohexylmethyl 3,4-epoxycyclohexanecarboxylate, 3,4-epoxy-2-methylcyclohexylmethyl 3,4-epoxy-2-methylcyclohexanecarboxylate and bis(3,4-epoxy-6-methylcyclohexylmethyl) adipate.

Preferred solid epoxy resins are bisphenol-A diglycidyl ethers, available for example from Olin (formerly DOW) under the designation D.E.R. 661, 6116, 662E, 6224, 662UH, 663U, 663UE, 664, 664U, 664UE.

Further solid epoxy resins known are based on phenol or cresol novolacs and are sold for example by DIC under the brand name Epiclon (600 series, 700 series and 800 series).

In accordance with the invention, the dynamic viscosity is determined in a cylinder rotation viscometer with a standard geometry according to DIN 53019-1 (2008-09). The viscosity is measured at a measuring temperature of 25° C. and a shear rate of 1/s. A “liquid” substance is one having a viscosity of less than 500 Pas.

With further preference, the reactive component comprises not more than 60% by weight of epoxycyclohexyl-based epoxy resins, more particularly from 5% to 80% by weight, more preferably from 15% to 60% by weight, based in each case on the total weight of the reactive component. Using liquid epoxycyclohexyl-based resins is beneficial to the technical adhesive properties of the reactive adhesives in the uncured state, especially when 10% to 40% by weight of such resins are used. Where, conversely, fractions of 40% to 80% by weight are used, the high reactivity of the epoxycyclohexyl derivatives enables production of reactive adhesive tapes which have an open time of at least 1 minute and thereafter cure very rapidly and completely within 24 h.

Epoxycyclohexyl-based epoxy resins may be selected, for example, from the group consisting of 3,4-epoxycyclohexylmethyl 3,4-epoxycyclohexanecarboxylate, 3,4-epoxy-2-methylcyclohexylmethyl 3,4-epoxy-2-methylcyclohexanecarboxylate, bis(3,4-epoxy-6-methylcyclohexylmethyl) adipate and bis((3,4-epoxycyclohexyl)methyl) adipate-dicyclopenta-diene dioxide and also combinations of these. These compounds are advantageous on account of their high reactivity, and may be used to produce very soft reactive adhesive tapes. Where firmer adhesive tapes are desired, this may be achieved by using polymers having epoxycyclohexyl groups, which are obtainable via radical polymerization of 3,4-epoxycyclohexylmethyl methacrylate, optionally with comonomers.

The reactive component may have an average functionality of alkylene oxide groups of 1.0 to 6.0, more particularly of 1.75 to 3.2, allowing high bond strengths to be achieved. The network density may be reduced via reactive diluents, leading to adhesives of low fragility, especially where fractions of reactive component are high. Such reactive diluents typically have a functionality of 1.0.

In one embodiment of the reactive adhesive tape of the invention, independently of one another the reactive adhesives or their reactive components each comprise at least two different epoxy resins B1 and B2, with the epoxy resin B1 having at 25° C. a dynamic viscosity of less than 500 Pa*s, measured according to DIN 53019-1 at a measuring temperature of 25° C. and a shear rate of 1/s, and the epoxy resin B2 having a softening temperature of at least 45° C. or at 25° C. a dynamic viscosity of at least 1000 Pa*s, measured according to DIN 53019-1 at a measuring temperature of 25° C. and a shear rate of 1/s, measured in each case with a cylinder rotation viscometer with a standard geometry. The fraction of epoxy resin B1 is preferably 10% to 90% by weight, more preferably 20% to 75% by weight, and the fraction of epoxy resin B2 is 10% to 90% by weight, preferably 25% to 80% by weight, based in each case on the total weight of the reactive component.

The molecular weight of the epoxide-containing material may vary from 58 to 50 000 g/mol.

A photoinitiator is a compound which is able to initiate a chemical reaction under the influence of high-energy radiation. The photoinitiator is preferably a UV initiator. UV initiators are known in principle to the skilled person. More preferably the photoinitiator is a UV initiator for cationic curing. With special preference, the photoinitiator is a sulfonium-, iodonium- or metallocene-based photoinitiator.

Anions which form the counterions for sulfonium-, iodonium- and metallocene-based photoinitiators are preferably selected from the group consisting of tetrafluoroborate, tetraphenylborate, hexafluorophosphate, perchlorate, tetrachloroferrate, hexafluoroarsenate, hexafluoroantimonate, pentafluorohydroxyantimonate, hexachloroantimonate, tetrakispentafluorophenylborate, tetrakis(pentafluoromethylphenyl)borate, bis-(trifluoromethylsulfonyl)amide and tris(trifluoromethylsulfonyl)methide. Further conceivable anions, particularly for iodonium-based initiators, are chloride, bromide or iodide, although preference is given to initiators substantially free of chlorine and bromine.

The photoinitiator is selected more particularly from the group consisting of triphenylsulfonium hexafluoroarsenate, triphenylsulfonium hexafluoroborate, triphenylsulfonium tetrafluoroborate, triphenylsulfonium tetrakis(pentafluorobenzyl)borate, methyldiphenylsulfonium tetrafluoroborate, methyldiphenylsulfonium tetrakis(pentafluorobenzyl)borate, dimethylphenylsulfonium hexafluorophosphate, triphenylsulfonium hexafluorophosphate, tri-phenylsulfonium hexafluoroantimonate, diphenylnaphthylsulfonium hexafluoroarsenate, tritolylsulfonium hexafluorophosphate, anisyldiphenylsulfonium hexafluoroantimonate, 4-butoxyphenyldiphenylsulfonium tetrafluoroborate, 4-chlorophenyldiphenylsulfonium hexafluoroantimonate, tris(4-phenoxyphenyl) sulfonium hexafluorophosphate, di(4-ethoxyphenyl)methylsulfonium hexafluoroarsenate, 4-acetylphenyldiphenylsulfonium tetrafluoroborate, 4-acetylphenyldiphenylsulfonium tetrakis(pentafluorobenzyl)borate, tris(4-thiomethoxyphenyl)sulfonium hexafluorophosphate, di(methoxysulfonylphenyl)methylsulfonium hexafluoroantimonate, di(methoxy-naphthyl)methylsulfonium tetrafluoroborate, di(methoxynaphthyl)methylsulfonium tetrakis-(pentafluorobenzyl)borate, di(carbomethoxyphenyl)methylsulfonium hexafluorophosphate, (4-octyloxyphenyl) diphenylsulfonium tetrakis(3,5-bistrifluoromethylphenyl)borate, tris [4-(4-acetylphenyl)thiophenyl]sulfonium tetrakis(pentafluorophenyl)borate, tris(dodecylphenyl)-sulfonium tetrakis(3,5-bis-trifluoromethylphenyl)borate, 4-acetamidophenyldiphenylsulfonium tetrafluoroborate, 4-acetamidophenyldiphenylsulfonium tetrakis(pentafluorobenzyl)borate, dimethylnaphthylsulfonium hexafluorophosphate, trifluoromethyldiphenylsulfonium tetrakis(pentafluorobenzyl)borate, tetrafluoroborate, trifluoromethyldiphenylsulfonium 5-methylthianthrenium hexa-phenylmethylbenzylsulfonium hexafluorophosphate, fluorophosphate, 10-phenyl-9,9-dimethylthioxanthenium hexafluorophosphate, 10-phenyl-9-oxothioxanthenium tetrafluoroborate, 10-phenyl-9-oxothioxanthenium tetrakis(pentafluoro-benzyl)borate, 5-methyl-10-oxothianthrenium tetrafluoroborate, 5-methyl-10-oxothianthrenium tetrakis(pentafluorobenzyl)borate, 5-methyl-10,10-dioxothianthrenium hexafluorophosphate; diphenyliodonium tetrafluoroborate, di(4-methylphenyl)iodonium tetrafluoroborate, phenyl-4-methylphenyliodonium tetrafluoroborate, di(4-chlorophenyl)iodonium hexafluorophosphate, di-naphthyliodonium tetrafluoroborate, di(4-trifluoromethylphenyl)iodonium tetrafluoroborate, di-phenyliodonium hexafluorophosphate, di(4-methylphenyl)iodonium hexafluorophosphate, di-phenyliodonium hexafluoroarsenate, di(4-phenoxyphenyl)iodonium tetrafluoroborate, phenyl-2-thienyliodonium hexafluorophosphate, 3,5-dimethylpyrazolyl-4-phenyliodonium hexafluoro-phosphate, diphenyliodonium hexafluoroantimonate, 2,2′-diphenyliodonium tetrafluoroborate, di(2,4-dichlorophenyl)iodonium hexafluorophosphate, di(4-bromophenyl)iodonium hexafluoro-phosphate, di(4-methoxyphenyl)iodonium hexafluorophosphate, di(3-carboxyphenyl)iodonium hexafluorophosphate, di(3-methoxycarbonylphenyl)iodonium hexafluorophosphate, di(3-methoxysulfonylphenyl)iodonium hexafluorophosphate, di(4-acetamidophenyl)iodonium hexafluorophosphate, di(2-benzothienyl)iodonium hexafluorophosphate, diaryliodonium tristrifluormethylsulfonylmethide, diphenyliodonium hexafluoroantimonate, diaryliodonium tetrakis(pentafluorophenyl)borate, diphenyliodonium tetrakis(pentafluorophenyl)borate, (4-n-desiloxyphenyl)phenyliodonium hexafluoroantimonate, [4-(2-hydroxy-n-tetradesiloxy)phenyl]-phenyliodonium hexafluoroantimonate, [4-(2-hydroxy-n-tetradesiloxy)phenyl]phenyliodonium trifluorosulfonate, [4-(2-hydroxy-n-tetradesiloxy)phenyl]phenyliodonium hexafluorophosphate, [4-(2-hydroxy-n-tetradesiloxy)phenyl]phenyliodonium tetrakis(pentafluorophenyl)borate, bis(4-tert-butylphenyl)iodonium hexafluoroantimonate, bis(4-tert-butylphenyl)iodonium hexafluorophosphate, bis(4-tert-butylphenyl)iodonium trifluorosulfonate, bis(4-tert-butylphenyl)iodonium tetrafluoroborate, bis(dodecylphenyl)iodonium hexafluoroantimonate, bis(dodecylphenyl)iodonium tetrafluoroborate, bis(dodecylphenyl)iodonium hexafluorophosphate, bis(dodecylphenyl)iodonium trifluoromethylsulfonate, di(dodecyl-phenyl)iodonium hexafluoroantimonate, di(dodecylphenyl)iodonium triflate, diphenyliodonium bisulfate, 4,4′-dichlorodiphenyliodonium bisulfate, 4,4′-dibromodiphenyliodonium bisulfate, 3,3′-dinitrodiphenyliodonium bisulfate, 4,4′-dimethyldiphenyliodonium bisulfate, 4,4′-bissuccinimidodiphenyliodonium bisulfate, 3-nitrodiphenyliodonium bisulfate, 4,4′-dimethoxy-diphenyliodonium bisulfate, bis(dodecylphenyl)iodonium tetrakis(pentafluorophenyl)borate, (4-octyloxyphenyl)phenyliodonium tetrakis(3,5-bis-trifluoromethylphenyl)borate and (tolylcumyl)iodonium tetrakis(pentafluorophenyl)borate, and η-5-(2,4-cyclopentadien-1-yl)-[(1,2,3,4,5,6,9)(1-methylethyl)benzene]iron.

The reactive adhesives may independently of one another each comprise one or more photoinitiators.

Where they comprise one or more photoinitiators, the reactive adhesives independently of one another contain photoinitiators preferably at in total 0.05% to 3%, more preferably at 0.1% to 1.5%, more particularly at 0.4% to 1.3% by weight, based in each case on the total weight of the reactive adhesive.

One preferred configuration according to the invention is therefore a reactive adhesive tape which comprises
a foil;
a first outer reactive adhesive; and
a second outer reactive adhesive;
   and which is characterized in that at least one of the reactive adhesives comprises (i) at least one epoxy resin at in total 18% to 60% by weight,
(ii) at least one photoinitiator at in total 0.05% to 3% by weight,
(iii) one or more foaming agents, and
(iv) at least one polymer at in total more than 60.0% by weight, more particularly 61.0% to 71.0% by weight, based on the total weight of the reactive adhesive, and
   in that this reactive adhesive is foamed.

In one embodiment of the reactive adhesive tape of the invention, at least one reactive adhesive comprises, and preferably independently of one another both reactive adhesives comprise, a photoinitiator whose anion is tetrakis(pentafluorophenyl)borate and/or hexafluorophosphate, more particularly tetrakis(pentafluorophenyl)borate. The photoinitiator may also consist of at least one such compound. Compounds having the aforesaid anion are particularly advantageous, since a photoinitiator of this kind affords a significantly increased dark reaction, with the adhesive tape thus curing more rapidly after radiation exposure.

Surprisingly, in spite of the use of such rapid photoinitiators, a comparatively long open time of at least three minutes, or particularly at least five minutes, can be achieved if additionally an open time additive is employed.

Particularly in the event of reactive adhesive tapes of the invention being intended to be used for bonding electronic components, suitability is also possessed by the hexafluorophosphate anion.

Beyond the constituents recited so far, independently of one another both reactive adhesives preferably each comprise at least one polymer. This polymer may be interpreted as a matrix-forming component or as a film-former. The reactive adhesives may in principle contain one or more polymers. The polymer is preferably selected from the group consisting of poly(meth)acrylates, poly(meth)acrylate block copolymers, polyurethanes, polyvinyl acetates, polyvinyl alcohols, polyethylene-vinyl acetates (EVA), nitrile rubber and polyesters, more preferably from the group consisting of poly(meth)acrylates, polyvinyl acetates and polyethylene-vinyl acetates. More particularly the polymer is a poly(meth)acrylate or a polyethylene-vinyl acetate.

A “polymer” in the reactive adhesive refers in the invention to a polymer having a weight-average molecular weight M_{w} of at least 100 000 g/mol.

The figures for the number-average molar mass Mₙ and the weight-average molar mass M_{w} in this specification relate to the determination by gel permeation chromatography (GPC), which is known per se. The determination is made on 100 μl of sample having undergone clarifying filtration (sample concentration 4 g/l). The eluent used is tetrahydrofuran with 0.1 vol % of trifluoroacetic acid. The measurement is made at 25° C.

The precolumn used is a PSS-SDV-type column, 5 μm, 10³ Å, 8.0 mm*50 mm (statements here and below in the following order: type, particle size, porosity, internal diameter×length; 1 Å=10-10 m). Separation takes place using a combination of the columns of type PSS-SDV, 5 μm, 10³ Å and also 10⁵ Å and 10⁶ Å each of 8.0 mm×300 mm (columns from Polymer Standards Service; detection by means of Shodex RI71 differential refractometer). The flow rate is 1.0 ml per minute. Calibration is carried out using the commercially available ReadyCal-Kit poly(styrene) high from PSS Polymer Standards Service GmbH, Mainz. The values are converted using the Mark-Houwink parameters K and alpha universally into polymethyl methacrylate (PMMA), and so the data are reported in PMMA mass equivalents.

The reactive adhesives independently of one another preferably comprise one or more polymers at in total 40.0% to 80.0% by weight, more preferably at in total more than 50% by weight, very preferably at more than 60.0% by weight, more particularly at more than 70.0% by weight, for example at 55.0% to 75.0% by weight or 61.0% to 71.0% by weight, based in each case on the total weight of the reactive adhesive.

In both reactive adhesives, independently of one another, the weight ratio of the reactive component, more particularly of the entirety of the epoxy resins, to the entirety of the polymers is preferably 1:5 to 1:1, more preferably 1:4 to 1:2, more particularly 1:3 to 1:1.5.

The term “poly(meth)acrylate” in the invention encompasses not only polymers based on esters of acrylic acid but also those based on esters of acrylic acid and methacrylic acid, and those based on esters of methacrylic acid.

The poly(meth)acrylate or poly(meth)acrylates of the reactive adhesives is or are preferably based on a monomer composition which consists of
(i) 45% to 85% by weight of one or more acrylic esters and/or methacrylic esters of the formula (I)

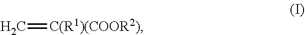

in which R¹ is a hydrogen atom or a methyl group and R² is an unsubstituted C₁-C₂₂ alkyl chain;
(ii) 10% to 50% by weight of one or more acrylic esters and/or methacrylic esters not corresponding to the formula (I) and/or of other vinyl compounds with functional groups, with the exception of epoxide groups and oxetane groups; and
(iii) 1% to 5% by weight of one or more acrylic esters and/or methacrylic esters not corresponding to the formula (I) and/or of other vinyl compounds with at least one epoxide or oxetane functionality, the weight fractions being based in each case on the total weight of the monomer composition.

The poly(meth)acrylates may be prepared in principle using all radical or radically controlled polymerizations, and combinations of different polymerization processes as well. In addition to the conventional, free radical polymerization, this also includes, for example, ATRP, nitroxide/TEMPO-controlled polymerization or the RAFT process. The poly(meth)acrylates may be prepared by copolymerization of the monomers using customary polymerization initiators and also, optionally, chain transfer agents, with polymerization taking place at the usual temperatures in bulk, in emulsion, as for example in water or liquid hydrocarbons, or in solution. The polymerization may be carried out in polymerization reactors, which are generally provided with a stirrer, multiple feed vessels, reflux condenser, heating and cooling and are equipped for operation under an N₂ atmosphere and superatmospheric pressure. The radical polymerization is conducted in the presence of one or more organic solvents and/or in the presence of water, or in bulk. The aim is to minimize the amount of solvent used. Depending on conversion and temperature, the polymerization time is generally between 6 and 48 hours. The weight-average molecular weight Mw of the polymers, determined via gel permeation chromatography, is preferably between 300 000 and 2 000 000 g/mol, preferably between 600 000 and 1 200 000 g/mol.

For solvent polymerization, solvents used are preferably esters of saturated carboxylic acids (e.g., ethyl acetate), aliphatic hydrocarbons (e.g., n-hexane or n-heptane), ketones (e.g., acetone or methyl ethyl ketone), special boiling point spirit, or mixtures of these solvents.

Preference is given to using a solvent mixture of acetone and isopropanol, the isopropanol content being between 1 and 10 percent by weight. Polymerization initiators used are commonly typical radical-forming compounds, such as peroxides and azo compounds, for example. Initiator mixtures as well may be used. In the polymerization, it is also possible to use thiols as chain transfer agents for lowering molecular weight and reducing the polydispersity. Other possible chain transfer agents in polymerization include, for example, alcohols and ethers.

In one embodiment, the poly(meth)acrylates are obtained via what is called the “syrup process”. For this, in an upstream step, the monomer composition undergoes preliminary polymerization to form a syrup. This syrup and, optionally, crosslinkable (meth)acrylate monomers are then used in the formulation of the reactive adhesive and are caused to react fully after the coating step, with, for example, light at a wavelength that does not activate the cationic initiator. This process can be used to obtain adhesive tapes with enhanced diecuttability.

The monomers (i) are preferably selected from the group consisting of methyl acrylate, methyl methacrylate, ethyl acrylate, ethyl methacrylate, propyl acrylate, propyl methacrylate, n-butyl acrylate, n-butyl methacrylate, n-pentyl acrylate, n-hexyl acrylate, n-hexyl methacrylate, n-heptyl acrylate, n-octyl acrylate, n-nonyl acrylate, lauryl acrylate, stearyl acrylate, stearyl methacrylate, behenyl acrylate and branched isomers thereof, especially 2-ethylhexyl acrylate; cyclohexyl methacrylate, isobornyl acrylate and isobornyl methacrylate. R² in the formula (I) is very preferably an unsubstituted C₁-C₈ alkyl chain, more particularly a C₁-C₄ alkyl chain.

The monomers (ii) are preferably selected from the group consisting of maleic anhydride, itaconic anhydride, hydroxyethyl acrylate, 4-hydroxybutyl acrylate, benzyl acrylate, benzyl methacrylate, phenyl acrylate, phenyl methacrylate, tert-butylphenyl acrylate, tert-butylphenyl methacrylate, tetrahydrofurfuryl acrylate, styrene, N-vinylphthalimide, methylstyrene, 3,4-di-methoxystyrene, and monomers of the formula (II)

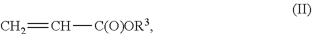

in which R³ is an alkoxyalkyl radical or a phenoxyalkyl radical.

The monomers (ii) are selected more preferably from the group consisting of phenoxyethyl acrylate, phenoxyethyl methacrylate, 2-butoxyethyl methacrylate, 2-butoxyethyl acrylate; more particularly, the monomers (ii) are selected from phenoxyethyl acrylate and phenoxyethyl methacrylate. With very particular preference, the monomers (ii) are phenoxyethyl acrylate.

The monomers (iii) are preferably selected from the group consisting of 3,4-epoxycyclohexylmethyl methacrylate, 3,4-epoxycyclohexylmethyl acrylate, glycidyl methacrylate, glycidyl acrylate and 3-ethyl-3-(methacryloyloxy)methyloxetane. With particular preference, monomers (iii) are present at in total 1 to 25 mol %, more preferably at in total 1.5 to 20 mol %, more particularly at in total 2 to 15 mol % in the parent monomer composition of the poly(meth)acrylate.

The comonomers (i) to (iii) of the poly(meth)acrylate are preferably selected such that the glass transition temperature T_{g} of the polymer is below the temperature of use, and preferably is ≤15° C. Moreover, the fractions in the monomer composition are preferably selected such that according to the Fox equation (E1) (cf. T.G. Fox, Bull. Am. Phys. Soc. 1956, 1, 123) a T_{g} of such a value is obtained for the poly(meth)acrylate.

$$\frac{1}{{T}_{G}} = {\sum }_{n} \frac{{w}_{n}}{{T}_{G , n}} \qquad ( E1 )$$

In this equation, n represents the serial number of the monomers used, Wₙ the mass fraction of the respective monomer n (% by weight), and T_{G,n} the respective glass transition temperature of the homopolymer of the respective monomers n, in K.

The reactive adhesives may contain one or more poly(meth)acrylates having a weight-average molar mass M_{w} of at least 100 000 g/mol.

Preferably, at least one of the two reactive adhesives and more preferably, independently of one another, both reactive adhesives each comprise at least one substance selected from the group consisting of polyethylene glycols (PEG), polypropylene glycols (PPG), tertiary amines and crown ethers; more particularly, at least one substance selected from PEG with a weight-average molecular weight, ascertained as described hereinabove, of 400 to 10 000 g/mol, for example up to 5000 g/mol, very preferably up to 1000 g/mol; and the crown ether compound 18-crown-6. An effect of these substances is that after the curing of the reactive adhesives has been initiated, there remains a time, referred to as the open time, during which curing does not yet ensue, or at least not yet to a significant extent, and consequently they may be referred to as “open time reagents”. As has emerged, with the open time reagents recited here, for UV-curable reactive adhesives in particular it is possible to achieve open times of at least one minute, frequently of 1 to 5 minutes, with the dark reaction being concluded after 24 hours at a temperature of 25° C. For the purposes of this invention, a reaction is referred to as “concluded” if the bond strength of the reactive adhesive tape after 24 h is at least 2 MPa.

The reactive adhesives may in principle comprise one or more open time reagents.

Where they are included, the aforesaid open time reagents are present in the reactive adhesives preferably at 0.1% to 10% by weight, more preferably at 0.2% to 5% by weight, more particularly at 0.3% to 4% by weight, based in each case on the total weight of the reactive adhesives.

In the invention, at least one of the reactive adhesives is foamed. A foamed material is a structure composed of three-dimensional, gas-filled cells which are bounded by liquid, semi-liquid or solid cell struts, or cell struts of relatively high viscosity, and which are present in a proportion such that the density of the foamed layer is reduced relative to the density of the matrix material, in other words of the entirety of the non-gaseous materials of which the material is composed.

With preference, independently of one another, both reactive adhesives are foamed.

In principle, the foaming of the matrix material in the reactive adhesives may be brought about or have been brought about in any desired way.

For example, the reactive adhesives may have been foamed via a propellant gas introduced or released in them. An example of a candidate propellant gas in this context is CO₂ or N₂, also possibly in the form of a supercritical fluid.

For release of a propellant gas, a propellant which decomposes thermally with release of gas may have been admixed to the reactive adhesives, alternatively or additionally, examples being NaHCO₃, the free acids or derivatives of citric acid, ascorbic acid, fumaric acid, gluconic acid or lactic acid, or exothermic propellants such as azodicarbonamide.

Mechanical foaming (frothing) as well is contemplated.

With preference, however, at least one, and more preferably, independently of one another, both of the reactive adhesives, is or are syntactically foamed. This means that the foam cells are not surrounded by the matrix material itself. Instead, with syntactic foams of this kind, the matrix material incorporates hollow spheres, composed of ceramic, polymer or glass, for example, which separate the cavities created from one another and from the matrix material by means of a membrane.

With particular preference, at least one and more preferably, independently of one another, both of the reactive adhesives comprises or comprise a multiplicity of expanded microballoons. This means that the syntactic foaming is achieved at least partly through the use of expanded microballoons, with the reactive adhesives having been syntactically foamed more particularly exclusively through expanded microballoons. “Microballoons” are hollow microspheres which are elastic, and can therefore be expanded in their base state, having a thermoplastic polymer shell. These spheres are usually filled with low-boiling liquids or liquefied gas. Shell materials used include, in particular, polyacrylic nitrile, PVDC, PVC or poly(meth)acrylates. Customary low-boiling liquids are, in particular, short-chain hydrocarbons, such as isobutane or isopentane, which are enclosed for example as a liquefied gas under pressure in the polymer shell.

Heating of the microballoons causes the outer polymer shell to soften. At the same time, the propellant inside expands. The microballoons undergo substantially irreversible expansion here, three-dimensionally. Expansion is at an end when the internal pressure matches the external pressure. Since the polymeric shell is retained, the result is a closed-cell, syntactically foamed foam.

Microballoons which have not undergone thermal activation and which accordingly still have their original expansion are referred to in the context of the present invention as unexpanded microballoons, and in agreement with the understanding of the skilled person they are not considered to be expanded microballoons.

Microballoons are available in a multiplicity of embodiments, which may be characterized essentially by way of their size (usually 6 to 45 μm diameter d50 in the unexpanded state) and by way of the onset temperatures they require for expansion (75 to 220° C.). Examples of commercially available microballoons are the Expancel® DU products (DU=dry unexpanded) from Nouryon or Matsumoto® Microspheres from Matsumoto Yushi-Seiyaku Co., Ltd. Unexpanded microballoons are available for example as an aqueous dispersion with a microballoon fraction by mass of around 40% to 45% or as polymer-bound products, in ethylene-vinyl acetate, for example, with a microballoon fraction by mass of around 65%. In the context of the present invention, however, it is preferable to use the unexpanded microballoons in powder form, with the powder preferably consisting substantially of the unexpanded microballoons.

The reactive adhesives of the reactive adhesive tape of the invention may in principle be produced either by adding already expanded microballoons to the matrix material or by first adding unexpanded microballoons to the matrix material and converting them into expanded microballoons subsequently by thermal exposure, with the latter procedure being explicitly preferred.

Owing to the inherent relationship between the properties and morphology of microballoons and the expansion temperature used and also the ambient pressure and/or the deformability of the matrix material, the present invention understands expanded microballoons to include at least partly expanded microballoons. This means that, relative to the unexpanded microballoons, the microballoons have been treated to a temperature greater than or equal to the respective onset temperature for at least long enough for there to be a volume expansion, preferably a volume expansion by more than 25%, more preferably more than 50%, very preferably more than 100%, especially preferably more than 150%. This means that the expanded microballoons need not necessarily have undergone complete expansion.

The skilled person is aware that the temperature chosen to foam the matrix material is dependent not only on the nature of the microballoons but also on the desired foaming rate. The absolute density of the respective material decreases successively as a result of continued foaming. The state of the lowest density which can be achieved at a particular temperature for a particular material by foaming with expanding microballoons is referred to as full expansion, full foaming, 100% expansion or 100% foaming.

While it may be challenging to give a precise definition of the expanded microballoons, as for all amorphous materials whose properties are determined critically by the process used for their production, the distinction between expanded and unexpanded microballoons is in practice, for the skilled person, happily just as simple as determining the full foaming, which in practice can be determined reliably and easily, at least with an error tolerance that is acceptable within the sector.

With preference at least one and more preferably, independently of one another, both reactive adhesives comprises or comprise one or more foaming agents, more preferably hollow spheres, more particularly microballoons, at in total 0.01% to 2% by weight.

One preferred configuration according to the invention is therefore a reactive adhesive tape which comprises
a foil;
a first outer reactive adhesive; and
a second outer reactive adhesive;
   and which is characterized in that at least one of the reactive adhesives comprises (i) at least one epoxy resin at in total 18% to 60% by weight,
(ii) at least one photoinitiator at in total 0.05% to 3% by weight,
(iii) one or more foaming agents at in total 0.01% to 2% by weight, and
(iv) at least one polymer at in total more than 60.0% by weight, more particularly 61.0% to 71.0% by weight, based on the total weight of the reactive adhesive, and
   in that this reactive adhesive is foamed.

In the case of solvent-containing reactive adhesives, the microballoons are preferably not expanded until after incorporation, coating, drying (solvent evaporation).

In the invention, therefore, DU products are preferably used.

Further to the components recited so far, the reactive adhesives independently of one another may each comprise further auxiliaries or adjuvants, examples being tackifier resins, rheology modifiers, fillers, adhesion promoters, polyols, aging inhibitors, light stabilizers, dyes, impact modifiers, phenoxy resins, or mixtures of these.

In principle, tackifier resins may be used for the present invention, but the reactive adhesives are preferably free from tackifier resins. If they nevertheless do contain tackifier resins, both room-temperature-solid resins and liquid resins may be employed. In order to ensure high aging stability and UV stability, preference is given to hydrogenated resins having a degree of hydrogenation of at least 90%, preferably of at least 95%.

Preferred fillers are selected from the group consisting of glass, particularly ground glass; talc, silicates, more particularly sheet silicates; and quartzes. The skilled person is aware that the amounts of fillers must be selected such that, where appropriate, the UV radiation required for curing is still able to penetrate the adhesive to a sufficient depth.

Further preferred additives for the reactive adhesives are as follows:
plasticizers, for example plasticizer oils, or low molecular weight liquid polymers, for example low molecular weight polybutenes, preferably with a proportion of 0.2 to 5 wt % based on the total weight of the reactive adhesive;
primary antioxidants, for example sterically hindered phenols, preferably with a proportion of 0.2 to 1 wt % based on the total weight of the reactive adhesive;
secondary antioxidants, for example phosphites or thioethers, preferably with a proportion of 0.2 to 1 wt % based on the total weight of the reactive adhesive;
process stabilizers, for example C radical scavengers, preferably with a proportion of 0.2 to 1 wt % based on the total weight of the reactive adhesive;
processing auxiliaries, preferably with a proportion of 0.2 to 1 wt % based on the total weight of the reactive adhesive.

Independently of one another, the reactive adhesives preferably contain optionally one or more adjuvants at in total 0.1 to 200 parts by weight, more preferably 50 to 150 parts by weight, more particularly 10 to 100 parts by weight, based in each case on 100 parts by weight of the other constituents of the reactive adhesive.

The reactive adhesives of the reactive adhesive tape of the invention may be produced and processed both from solution and from the melt (hotmelt process). Application of the adhesives to the central plies of the reactive adhesive tape of the invention, more particularly to the foil, may be accomplished by direct coating or by lamination.

In a typical process for producing a reactive adhesive of the reactive adhesive tape of the invention, all the constituents of the adhesive are dissolved or dispersed in a solvent or a solvent mixture such as 2-butanone/acetone, for example. The microballoons are, for example, slurried in acetone or butanone and incorporated by stirring into the dispersed or dissolved adhesive.

In a preferred process step, to prevent solvent-induced damage to the microballoons, the microballoons are slurried in a solvent and their working life from the time of this slurrying to the application, by coating, of the reactive adhesive containing the microballoons is less than 8 h, more preferably less than 6 h, more particularly less than 4 h.

For the incorporation of the components by stirring, and the mixing of them, the known compounding and stirring units may be used in principle, in which case it should be ensured that the microballoons do not yet expand during mixing. The reactive adhesive may be applied using prior-art coating systems, such as with a doctor blade, onto a release liner. In the next step, the applied adhesive may be dried in a drying tunnel or drying oven. Expansion of the microballoons is not intended in any of the aforesaid steps. After drying has taken place, the layer of reactive adhesive may be lined with a second ply of PET liner and foamed in an oven within an appropriate temperature window, for example at 130° C. to 180° C., and may be covered between the two liners or else between a liner and the carrier, in order to produce a particularly smooth surface. Foaming may be brought to an end by prompt cooling, for example to room temperature (20-25° C.) so that the desired degree of foaming is established.

Alternatively, the foil may also be coated with one or both reactive adhesives in a solvent-free process. For this, the base polymer can be heated and melted in an extruder. Additional operating steps such as mixing with further components, filtration or degassing may take place in the same or in a downstream extruder. The melt can then be coated onto the foil using a roll calendar.

Suitable UV radiation sources for initiating the crosslinking of the reactive adhesives in the relevant embodiment include, for example, mercury vapor lamps or corresponding UV-LED sources. UV crosslinking of the reactive adhesives is brought about preferably via brief ultraviolet irradiation in a wavelength range from 200 to 400 nm, more particularly using high-pressure or medium-pressure mercury lamps at a power of 80 to 200 W/cm².

A further subject of the invention is the use of a reactive adhesive tape of the invention as bonding agent in the production of electronic, optical or precision-mechanical devices, more particularly portable electronic, optical or precision-mechanical devices.

Such portable devices are more particularly:
cameras, digital cameras, photographic accessories (such as exposure meters, flashguns, diaphragms, camera casings, lenses, etc.), film cameras, video cameras;
microcomputers (portable computers, pocket computers, pocket calculators), laptops, notebooks, netbooks, ultrabooks, tablet computers, handhelds, electronic diaries and organizers (so-called “personal digital assistants”, PDAs, palmtops), modems;
computer accessories and operating units for electronic devices, such as mice, drawing pads, graphics tablets, microphones, speakers, games consoles, gamepads, remote controls, remote operating devices, touchpads;
monitors, displays, screens, touch-sensitive screens (sensor screens, touchscreen devices), projectors;
reading devices for electronic books (“e-books”);
mini TVs, pocket TVs, devices for playing films, video players;
radios (including mini and pocket radios), Walkmans, Discmans, music players for, e.g., CD, DVD, Blu-ray, cassettes, USB, MP3; headphones;
cordless telephones, cell phones, smart phones, two-way radios, hands-free telephones, devices for summoning people (pagers, bleepers);
mobile defibrillators, blood sugar meters, blood pressure monitors, step counters, pulse meters;
torches, laser pointers;
mobile detectors, optical magnifiers, binoculars, night vision devices, GPS devices, navigation devices, portable interface devices for satellite communication;
data storage devices (USB sticks, external hard drives, memory cards); and
wristwatches, digital watches, pocket watches, fob watches, and stopwatches.

A reactive adhesive tape of the invention is used more particularly as a bonding agent in the production of smart phones (cell phones), tablets, notebooks, cameras, video cameras, keyboards or touchpads.

Further elucidated and described below are preferred embodiments of the invention with reference to experiments.

### A. Raw Materials Used:

| | |
|---|---|
| Levapren 700 | Polyethylene-vinyl acetate with 70% vinyl acetate, from Lanxess |
| Polyacrylate | Tacky acrylate copolymer of ECHMA, BA, MA; Mn = around 650 |
| | 000 g/mol |
| Epikote 828 LVEL | Distilled, difunctional bisphenol-A/epichlorohydrin liquid epoxide |
| | with a weight per epoxide of 185 to 192 g/eq from Hexion, with a |
| | viscosity at 25° C. of 10 to 12 Pa*s |
| Araldite GT 7072 | Solid, bisphenol-A-based epoxy resin from Huntsman, with a |
| | softening temperature of 82-90° C. |
| Uvacure 1500 | (3,4-Epoxycyclohexylmethyl 3,4-epoxycyclohexanecarboxylate |
| | CAS 2386-87-0) |
| | Liquid cycloaliphatic diepoxide from Dow with a melting point of - |
| | 37° C. and a viscosity at 23° C. of 0.25 Pa*s |
| Araldite ECN 1299 | Solid epoxy-cresol novolac from Huntsman with a softening |
| | temperature (DIN 519219) of 85 to 100° C. |
| Triarylsulfonium | Cationic photoinitiator from Sigma-Aldrich. |
| hexafluorophosphate | 50% solution in propylene carbonate |
| Irgacure PAG290 | Cationic photoinitiator from BASF. The counterion is a |
| | tetrakis(pentafluorophenyl)borate anion. |
| Expancell DU20 | Expandable hollow microspheres for foaming from Akzo Nobel |

### B. Production of Polyacrylate:

A 4 L reactor conventional for radical polymerizations was charged with 95 g of 3,4-epoxycyclohexylmethyl methacrylate (ECHMA), 510 g of butyl acrylate (BA), 395 g of methyl acrylate (MA) and 785 g of acetone/isopropanol (90:10). After passage of nitrogen gas through the charge with stirring for 45 minutes, the reactor was heated up to 58° C. and 0.25 g of 2,2′-azobis(2-methylbutyronitrile) was added. The external heating bath was then heated to 63° C. and the reaction was carried out constantly at this external temperature. After a reaction time of 1 h, 0.75 g of 2,2′-azobis(2-methylbutyonitril) was added. To reduce the residual initiators, portions of 0.12 g of di(4-tert-butylcyclohexyl) peroxydicarbonate were added after 6.5 h and after 8 h. After 7.5 h, dilution took place with 120 g of acetone. After a reaction time of 24 h, the reaction was terminated and the product cooled to room temperature. The polyacrylate obtained has a number-average molecular weight Mn of around 650 000 g/mol as determined via GPC.

### C. Production of the Pressure-Sensitive Adhesives (PSAs)/Adhesive Layers:

### K1.1 and K2.1:

The PSAs were produced in the laboratory in accordance with the quantity figures in table 1 below. The respective polymer was first dissolved in butanone at 23° C. The epoxy resin or resins were then added. Subsequently, the photoinitiator was added by stirring.

To produce adhesive layers, i.e., the carrierless (pressure-sensitive) adhesive tapes, the various adhesives were applied from a solution to a conventional liner (siliconized polyester foils) using a laboratory coater, and dried. The size of the adhesive layer was approximately 21 cm×30 cm and the adhesive layer thickness after drying is 100±5 μm (see table 2 below, product structure V2). Drying took place in each case first at RT for 15 minutes and for 15 minutes at 120° C. in a laboratory drying cabinet. The dried adhesive layers were each laminated, immediately after drying, with a second liner (siliconized polyester foil of lower release force) on the open side.

### K1.2, K2.2 and Comparative Adhesive VK1:

The PSAs were produced in the laboratory in accordance with the quantity figures (in parts by weight) in table 1 below. The respective polymer was first dissolved in butanone at 23° C. The epoxy resin or resins were then added. The photoinitiator was added subsequently by stirring. The solution was admixed with unexpanded Expancell DU 20 microballoons, the microballoons having been slurried with acetone beforehand.

To produce adhesive layers, i.e., the carrierless (pressure-sensitive) adhesive tapes, the various adhesives were applied from a solution to a conventional liner (siliconized polyester foils) using a laboratory coater, and dried. The size of the adhesive layer was approximately 21 cm×30 cm and the adhesive layer thickness after drying is dependent on product structure (see table 2 below) and is 40±5 μm (product structure P1, P2 and V3) or 90±5 μm (product structure V1). Drying took place in each case first at RT for 15 minutes and for 15 minutes at 120° C. in a laboratory drying cabinet. The dried adhesive layers were each laminated, immediately after drying, with a second liner (siliconized polyester foil of lower release force) on the open side.

TABLE 1
PSA composition, all figures in parts by weight:

| PSAs | K1.1 | K1.2 | K2.1 | K2.2 | VK1 |
|---|---|---|---|---|---|
| Levapren 700 | 61 | 61 | | | |
| Polyacrylate | | | 70 | 70 | 20 |
| Epikote 828 LVEL | 10 | 10 | 5 | 5 | |
| Araldite GT 7072 | 12 | 12 | 14 | 14 | |
| Uvacure 1500 | 15 | 15 | 10 | 10 | 40 |
| Araldite ECN 1299 | | | | | 40 |
| Triarylsulfonium | 1.5 | 1.5 | 1.5 | 1.5 | |
| hexafluorophosphate, mixed salts | | | | | |
| 50% in propylene carbonate | | | | | |
| Irgacure PAG290 | | | | | 1 |
| Expancell DU20 | | 1 | | 1 | 1 |

### D. Production of Adhesive Tapes:

### Product Structure P1, P2 and V3:

The double-sided adhesive tapes are produced from the adhesive layer is produced (and as yet unfoamed), taking account of the respective product structure, as indicated in table 2 below. To produce the tapes, after removal of one of the two liners, the adhesive layers produced are applied over the full area to the top and bottom sides of a 12 μm PET foil etched on both sides with trichloroacetic acid. These adhesive tapes are then partially foamed for 20 seconds at 160° C. between the two liners in an oven. The thickness of the adhesive layer after cooling to room temperature (20° C.) was 100 μm (+5 μm).

### Product Structure V1:

The carrierless (pressure-sensitive) adhesive tape 90 μm thick produced as described above (with K2.2 as adhesive) was partially foamed for 20 seconds at 160° ° C. between the two liners in an oven. The thickness of the adhesive layer after cooling to room temperature (20° C.) was 100 μm (+5 μm).

### Product Structure V2:

Corresponds to the carrierless (pressure-sensitive) adhesive tape 100 μm thick produced as described above (with K2.1 as adhesive).

TABLE 2
Product structure of the double-sided adhesive tapes:

| Product structure | P1 | P2 | V1 | V2 | V3 |
|---|---|---|---|---|---|
| Outer layer 1 (50 μm) | K2.1 | K2.2 | K2.2 | K2.1 | VK1 |
| Carrier foil | 12 μm PET | 12 μm PET | no | no | 12 μm PET |
| Outer layer 2 (50 μm) | K1.2 | K2.2 | K2.2 | K2.1 | VK1 |
| Foamed | yes | yes | yes | no | yes |
| Peel adhesion (steel) | >1 | >1 | >1 | >1 | >1 |
| [N/cm] | | | | | |
| Cuttability | ◯ | ◯ | X | X | X |
| Shock [mJ/cm²] | >150 | >150 | >150 | <150 | <150 |

Of the adhesive tapes produced, the bond strength and the peel adhesion were measured, and the cuttability was evaluated. The results were recorded in table 2.

The inventive product structures P1 and P are not only pressure-sensitive adhesive but also sufficiently cohesive, and so pass the cuttability test. This is considered an indicator of whether a pressure-sensitive adhesive tape can be diecut in a subsequent industrial operation. In spite of the good cuttability, the inventive product structures display very good shock properties of more than 150 mJ/cm². In contrast to this, product structure V3 shows that the combination of adhesive composition, carrier foil and foaming, in accordance with the invention, is important. In comparative examples VK1/V3, a prior-art reactive adhesive was used, from WO 2017/174303 A1. Although the product structure with carrier foil and foaming chosen was the same, cuttability is not provided, presumably because of the much too low polymer fraction.

Conversely, with the non-inventive product structures V1 and V2, in spite of the use of inventive adhesives (K2.2 and K2.1), the resulting product structures are again not cuttable.

### E. Test Methods:

Unless otherwise noted, the measurements were conducted under test conditions of 23° C.±1° C. and 50±5% relative humidity.

### Peel Adhesion:

The peel adhesions on steel were determined in analogy to ISO 29862 (Method 3) with a removal velocity of 300 mm/min and a removal angle of 180°. The reinforcing foil used was an etched PET foil having a thickness of 36 μm, as available from Coveme. The test strip was bonded here by means of a roll-on machine with 4 kg at a temperature of 23° C. The adhesive tapes were removed immediately after application. The measured value (in N/cm) was obtained as the mean value from three individual measurements.

### Shock Test:

The shock test provides information about the bond strength of an adhesive product in a direction normal to the adhesive layer. Provided are a circular first substrate (1) (polycarbonate, Macrolon 099, thickness 3 mm) with diameter 21 mm, a second substrate (2) (polycarbonate, Macrolon 099, thickness 3 mm)—for example, in a square shape with a side length of 40 mm—with a circular opening (bored hole) arranged centrally and 9 mm in diameter, and the adhesive film sample for investigation, which was likewise produced circularly with a diameter of 21 mm (cut to size or diecut).

From the aforesaid three components, a test element is produced by bonding the adhesive product to the substrate (1) by the free surface in an exact match. The temporary protective foil (siliconized PET liner) is then removed and activation takes place with at least 1000 mJ/cm² from a 365 nm UV-LED (Hönle AG). This assembly is applied concentrically, by the now exposed side of the adhesive product, to the substrate 2 within 2 minutes, specifically such that the circular cut-out in the substrate 2 is positioned precisely centrally above the circular first substrate 1 (with a resulting bond area of 282 mm²), and is compressed with a pressure of at least 10 bar for at least 10 s, to produce the test element.

After having been compressed, the test elements are conditioned for 72 hours at 23° C./50% relative humidity. After storage, the bonded assembly is clamped into a sample holder, so that the assembly is aligned horizontally. The test element with the polycarbonate sheet (substrate 1) is inserted downward into the sample holder. The sample holder is subsequently inserted centrically into the intended holder of the “DuPont Impact Tester”. The impact head is inserted such that the circular, rounded striking geometry with the diameter of 5 mm lies centrically and flush on the bonding side of the substrate 1. A weight guided on two rods and having a mass of 307 g is caused to drop perpendicularly from a height of initially 5 cm (test conditions 23° C., 50% relative humidity). The height from which the weight is dropped is increased in steps of 5 cm until the impact energy introduced destroys the sample as a result of the impact load, and the polycarbonate sheet (substrate 1) parts from the baseplate (substrate 2). In order to be able to compare experiments with different samples, the energy is calculated as follows:

DuPont shock [mJ]=(m(carriage)[kg]*9.81[kg/m*s²]*h[m]/A(bond area)[cm²]

Three samples per product are tested, and the mean energy value is reported as an index of the impact strength.

Instrument: DuPont Impact Tester (from Cometech, TAIWAN, model QC-641)

The curing reaction was activated with UV light before the bonding of the second substrate (dose >4500 mJ/cm2, lamp type: UV-Led 365 nm). Measurement took place 48 h after activation.

### Cuttability:

A specimen with dimensions of 5 cm×5 cm was cut out from the test double-sided adhesive tape (with liners). The specimen cut out was fastened on one side to a standard commercial adhesive tape in order to prevent slipping. Using a cutter, the respective sample was cut through completely along its length to form two parts (part A and part B). The cut length was 5 cm. After the cutting, the cut faces of part A and part B were left in the original position for 3 s, so that the cut faces were in direct contact with one another. Subsequently, part B was pulled, with the position of part A unchanged. A measurement was made of the degree of extraction of adhesive at the cutting face (“stringing”) between part A and part B. The parameter measured was the distance traveled, being the distance beyond which the two cut faces were not connected by adhesive.

The evaluation standard was as follows:
O: the degree of extraction of adhesive was less than 5 mm
X: the degree of extraction of adhesive was more than 5 mm

1. A reactive adhesive tape comprising
a foil;
a first outer reactive adhesive; and
a second outer reactive adhesive;
wherein at least one of the reactive adhesives is foamed and comprises:
(i) at least one reactive component, especially preferably an epoxy resin,
(ii) at least one photoinitiator,
(iii) one or more foaming agents, especially preferably hollow spheres, and
(iv) at least one polymer at in total more than 60.0% by weight, based on the total weight of the reactive adhesive.

2. The reactive adhesive tape of claim 1, wherein the at least one polymer is selected from the group consisting of: poly(meth)acrylates, poly(meth)acrylate block copolymers, polyurethanes, polyvinyl acetates, polyvinyl alcohols, polyethylene-vinyl acetates, nitrile rubber and polyester.

3. The reactive adhesive tape of claim 2, wherein the at least one polymer is selected from the group consisting of: poly(meth)acrylates, polyvinyl acetates and polyethylene-vinyl acetates.

4. The reactive adhesive tape of claim 1, wherein the foil is selected from the group consisting of: polyethylene terephthalate foils (PET foils), polyethylene foils (PE foils), polypropylene foils (PP foils) and polyurethane foils (PU foils).

5. The reactive adhesive tape of claim 1, wherein the foil is a polyethylene terephthalate foil (PET foil).

6. The reactive adhesive tape of claim 1, wherein the at least one reactive adhesive comprises:
(i) at least one epoxy resin at in total 18% to 60% by weight,
(ii) at least one photoinitiator,
(iii) one or more foaming agents, and
(iv) at least one polymer at in total more than 60.0% by weight, based on the total weight of the reactive adhesive.

7. The reactive adhesive tape of claim 1, wherein each of the reactive adhesives comprise one epoxy resin and a UV initiator which may be the same or different.

8. The reactive adhesive tape of claim 1, wherein at least one of the reactive adhesives comprises at least one cycloaliphatic epoxy resin.

9. The reactive adhesive tape of claim 1, wherein, independently of one another, one or both reactive adhesives each comprise at least one liquid and at least one solid epoxy resin and further wherein the liquid epoxy resin:solid epoxy resin weight ratio is 1:3 to 3:1.

10. The reactive adhesive tape of claim 1, wherein that independently of one another, both reactive adhesives each comprise at least one poly(meth)acrylate and the parent monomer composition of the poly(meth)acrylate comprises one or more monomers which contain at least one cyclic ether group.

11. The reactive adhesive tape of claim 1, wherein that, independently of one another, one or both reactive adhesives are syntactically foamed.

12. The reactive adhesive tape according to claim 1, wherein that, independently of one another, one or both reactive adhesives comprise a multiplicity of expanded microballoons.

13. A method producing electronic, optical or precision-mechanical devices, wherein devices are produced with the reactive adhesive tape of claim 1.
